(19) United States
(12) Patent Application Publication
(10) Pub. No.: US 2008/0048472 A1
(43) Pub. Date: Feb. 28, 2008

(54) Extendable Seat System for a Host

(76) Inventors: Rainer Kuenzel, Hunt, TX (US); Charles Fred Washington III, Kerville, TX (US)

Correspondence Address: TIM COOK, P.O. BOX 10107, LIBERTY, TX, 77575, US

(21) Appl. No.: 11/933,466

(22) Filed: Nov. 1, 2007

Related U.S. Application Data
(63) Continuation-in-part of application No. 11/668,527, filed on Jan. 30, 2007.
(60) Provisional application No. 60/767,329, filed on Mar. 18, 2006.

(51) Int. Cl. A47C 3/40; A47C 1/00; A47C 3/00; B60N 2/00; E02B 17/00; A47C 7/66; A47C 3/30

(52) U.S. Cl. 297/184.15; 108/20; 297/344.19

(57) ABSTRACT

A seat for a fishing or bass boat can be raised or lowered by an operator. The elevation mechanism preferably includes a power mechanism to operate a screw jack and the power mechanism may be battery powered, hydraulically powered, or operated by other power-assist means. The screw jack enables the seat to be raised to approximately twice its retracted height.

This application is a Continuation in Part of U.S. patent application Ser. No. 11/668,527; filed Jan. 30, 2007; which claims the benefit of U.S. Provisional Patent Application Ser. No. 60/767,329 filed Mar. 18, 2006.

### FIELD OF THE INVENTION

The present invention relates generally to the field of seats installed in fishing boats and the like and, more particularly, to a power pedestal mounting for a bass boat or other vehicle seat so that the seat can be raised and lowered.

### BACKGROUND OF THE INVENTION

Pleasure boats such as fishing or bass boats are typically equipped with one or more swiveling seats. Such swiveling seats are mounted in a recessed hole or base in the raised deck of the boat. The seats thus provide a somewhat raised position for the angler who wants a better view of what is going on below the surface of the water.

However, in most cases, the height of the boat seat is fixed, and thus does not afford an adequate view for the average fisherman. Consequently, the angler usually has to stand up to get a satisfactory view, or even climb up on a stepladder or similar structure, to get a better view. This kind of activity is at best inconvenient and at worst dangerous to the fisherman and to others in the boat with him.

Thus, there remains a need to a bass boat seat that can be raised or lowered by the fisherman at his desire to afford a better view of his surroundings, including the activity below the surface in the immediate vicinity of the boat. The seat system should be adaptable to other vehicles, including all terrain vehicles. The present invention is directed to fulfilling this need in the art.

### SUMMARY OF THE INVENTION

The present invention provides a seat for a fishing or bass boat or other vehicle, the seat being capable of being raised or lowered by an operator. The elevation mechanism preferably includes a power mechanism to operate a hydraulically powered telescoping mechanism. The mechanism enables the seat to be raised to approximately twice its retracted height.

The present invention further includes a foot rest or platform which is mechanically coupled to the seat and is adapted to be releasable mounted to a vehicle.

The mechanism to raise and lower the seat/foot platform assembly includes a control mechanism that may be hand-held or foot-operated so that the seat can be controlled remotely, if desired.

These and other features and advantages of the present invention will be readily apparent to those of skill in the art from a review of the following detailed description.

### BRIEF DESCRIPTION OF THE DRAWINGS

FIG. 1 is a side elevation view of the boat seat assembly of the present invention shown in partial cross section.

FIG. 2 is a side elevation view of the boat seat in partial section, illustrating the boat seat assembly in a partially raised position.

FIG. 3 is a side elevation detail view in partial section of a seat and swivel arrangement.

FIG. 4 is a top view of the seat of FIG. 3, as shown by the view lines 4-4 on FIG. 3.

FIG. 5 is a top view of a foot platform, as indicated by view lines 5-5 on FIG. 1.

FIG. 6 is a side view in partial section taken along view lines 6-6 of FIG. 5, illustrating the attachment mechanism of the foot platform to the center post.

FIG. 7 is a section view of a foot-operated remote control transmitter as indicated by the view lines 7-7 of FIG. 9.

FIG. 8 is a section of a detail of the seat mount as indicated by the view lines 8-8 in FIG. 7.

FIG. 9 is a section view of a detail of the seat mount as indicated by the view lines 9-9 in FIG. 7.

FIG. 10 is a section view of the foot-operated remote control transmitter of FIG. 7, shown in a depressed state.

FIG. 11 is an electrical schematic diagram of a control circuit which finds application in the present invention.

FIG. 12 is a side elevation section view of another preferred embodiment of seat of the present invention.

FIG. 13 is a side elevation section view of the seat of FIG. 12, shown in a partially raised position.

FIG. 14 is a plan view of a mounting plate, as viewed along section lines 14-14 of FIG. 12.

FIG. 15 is a side section view of a mounting mechanism for the foot platform as viewed along section lines 15-15 of FIG. 14.

FIG. 16 is an elevation view in partial section as seen along section lines 16-16 of FIG. 14.

FIG. 17 is a side elevation view of the boat seat assembly of another preferred embodiment of the present invention shown in partial cross section

FIG. 18 is a side elevation view of the boat seat of FIG. 17 in partial section, illustrating the boat seat assembly in a fully raised position.

FIG. 19 is a side elevation view of a seat in a raised position and mounted to a terrain vehicle, rather than on a vessel as previously described.

FIG. 20 is a side elevation view of the seat, as illustrated in FIG. 19, in a partially stowed condition for traveling.

FIG. 21 is a side elevation view of the seat in a stowed condition, with the seat rotated down and out of the way for traveling.

FIG. 22 is a detail view of a preferred mounting frame for mounting the seat on a vehicle.

### DETAILED DESCRIPTION OF PREFERRED EMBODIMENTS

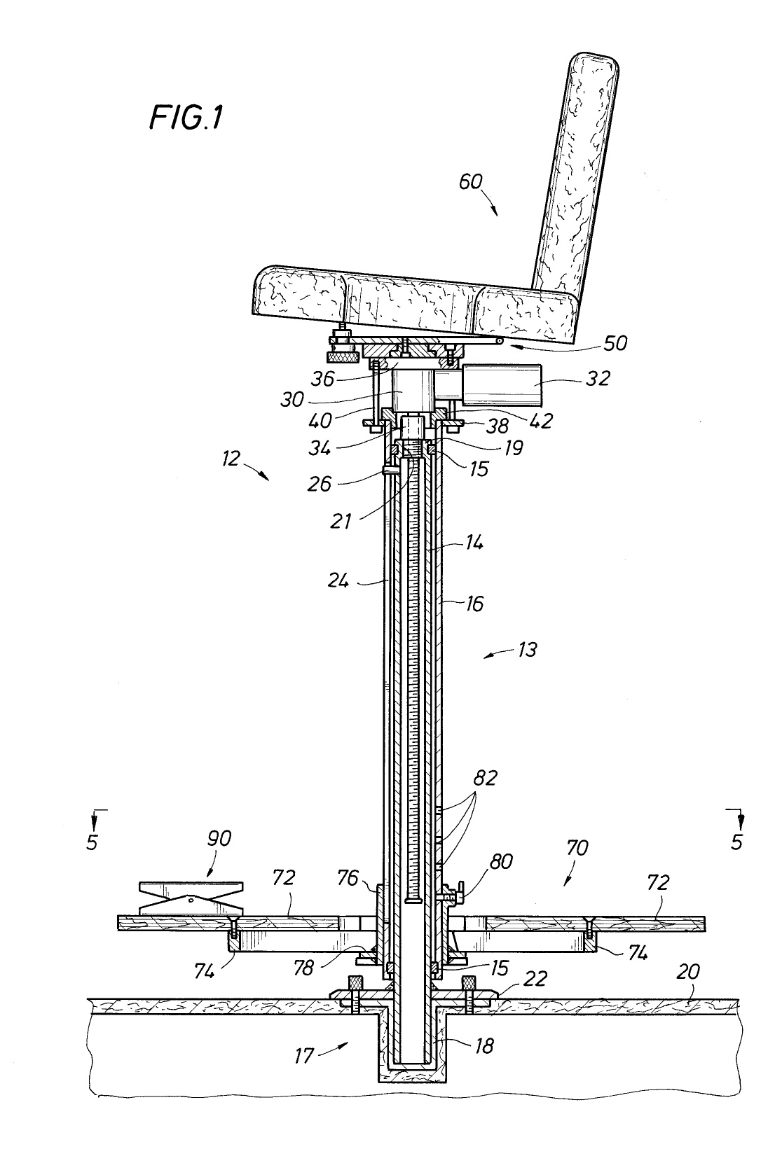

In FIG. 1, a seat assembly 12 of the present invention is shown in partial cross section. The seat assembly primarily comprises a seat 60, an elevation mechanism 13, and a mounting structure 17. The elevation mechanism includes an inner post 14 and an outer post 16, which telescope in relation to one another. The inner post 14 extends downward into the mounting structure, including a sleeve 18, which is securely affixed to a fiberglass boat deck 20. For greater stability, a plate 22 may be welded to the inner post 14 and bolted to the deck 20.

The outer post 16 is slidably positioned over the inner post 14 and is equipped with a longitudinal slot 24. A pin 26 is attached to the inner post 14 and rides in the slot 24 of the outer post 16, thus allowing the outer post 16 to slide up and down but preventing it from rotating on the inner post 14.

Slip rings 15 are mounted on the top outer surface of the inner post 14 and ride on the inside surface of the outer post 16 to reduce friction between the two posts as the seat 60 is run up and down. The top of the inner post 14 defines a cap 19 with a hole 21 through it. A screw or spindle 28 extends through the hole 21 and runs up to a gear box 30 of a worm gear that is driven by a prime mover 32, described hereinafter as a motor 32, although the prime mover may also be a hydraulic or pneumatic power source, or even a manually operated prime mover. A nut 34, which is threadedly engaged with the screw 28, is mounted onto the upper end of inner post 14.

A motor 32 and a gear box 30 are mounted between a motor mounting plate 38 and a hold down plate 36. The plates 36 and 38 are joined together by bolts 40 and serve to clamp the motor gear box 30 in a position fixed to the upper end of the outer post 16. A spacer 42 holds the gearbox 30 and the spindle 28 in a position concentric with the nut 34 and the inner post 14. Thus, in this preferred embodiment, the motor and gear box are located between the seat 60 and the top of the outer post 16.

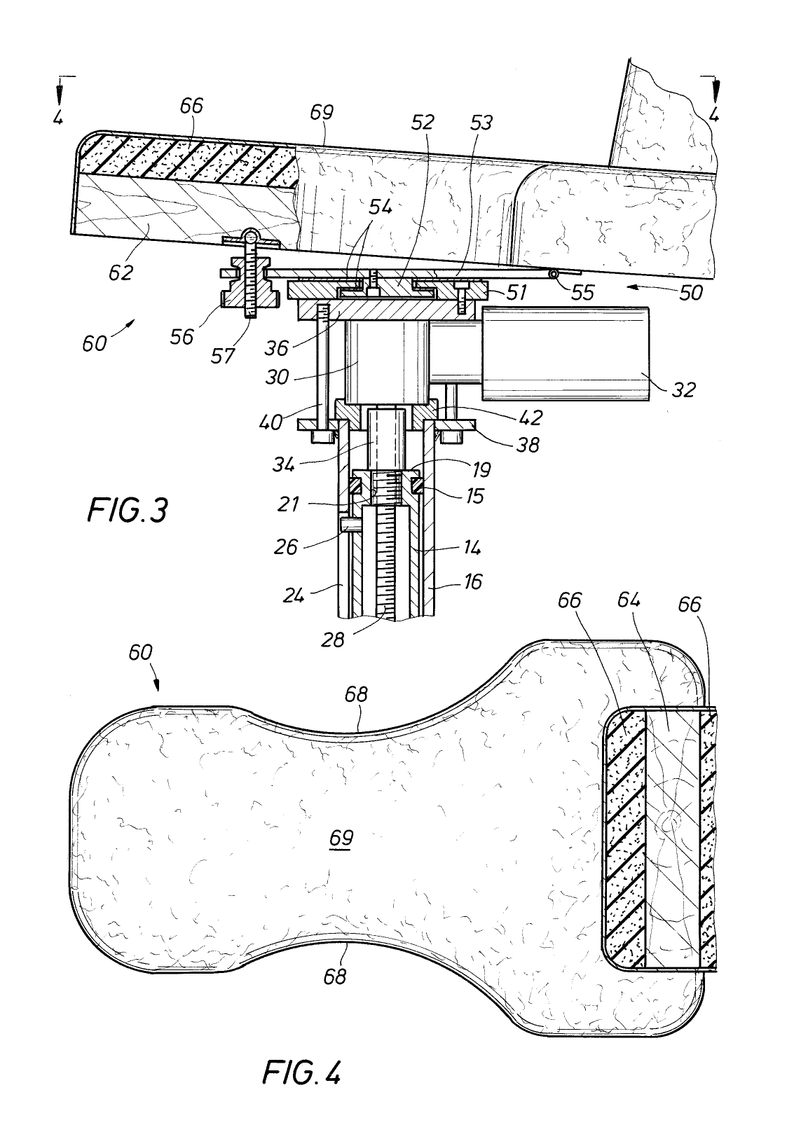

The seat 60 is secured to the assembly with a seat swivel 50. The seat swivel is mounted on top of the plate 36. Details of the seat and seat swivel are described below in relation to FIG. 3.

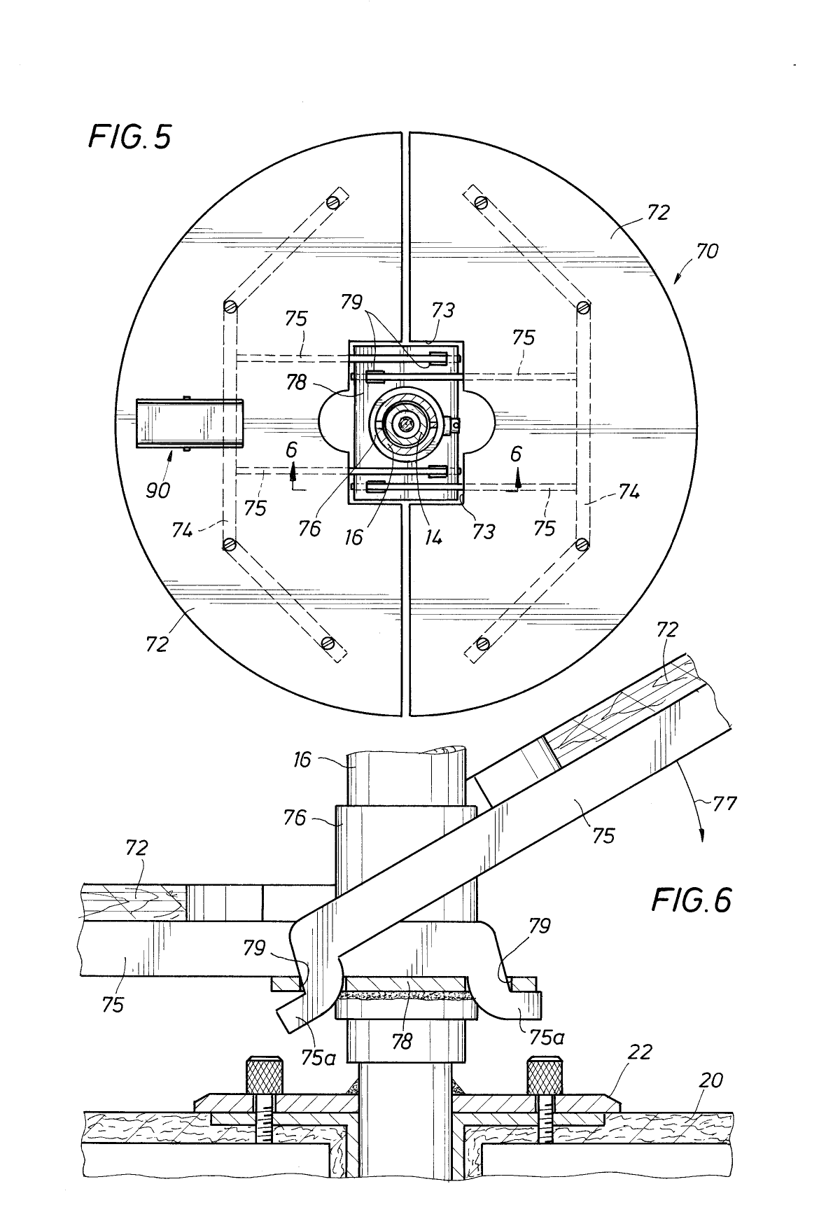

Surrounding the lower end of the outer post 16 is a foot platform 70, comprising a pair of platform halves 72 and an under carriage 74. The under carriage 74 engages a sleeve 76 which is secured to the outer surface of the outer post 16. The sleeve 76 also includes an outwardly extending plate 78 which provides vertical support for the foot platform 70. A foot operated remote control device 90, described in greater detail below, is preferably mounted on the platform 70 where it can be easily reached by the angler's foot. The sleeve 76 can be raised along with the platform halves 72 to a position that is higher and closer to the seat 60, if a person with shorter legs prefers to do so. To hold the foot platform at a desired distance below the seat 60, a pin 80 engages a selected hole 82 in the wall of the outer post 16. Details of the platform are described below in relation to FIG. 5 and FIG. 6.

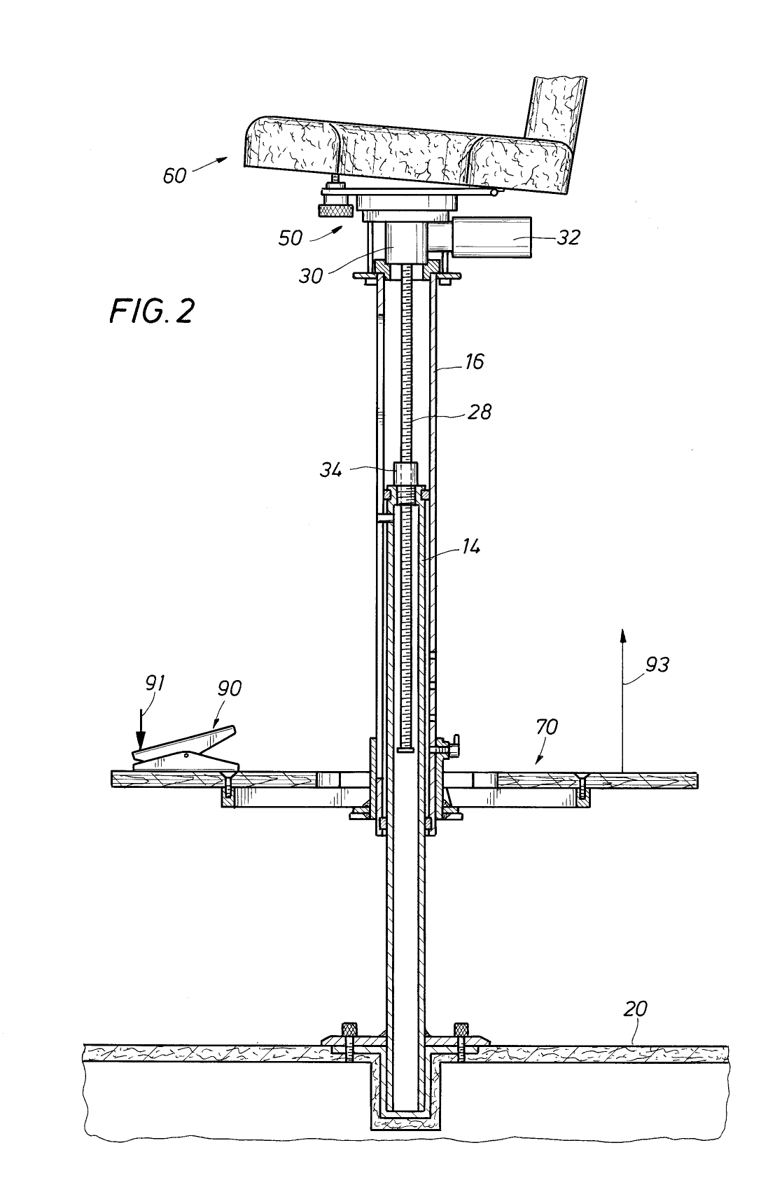

In the preceding description in respect of FIG. 1, the seat 60 is illustrated in a lowered or “down” position. FIG. 2 shows the seat 60 in a partially raised position. The remote control 90 has been activated, as illustrated by an arrow 91, showing that the foot pedal has been depressed. Activation of the control 90 energizes the motor 32, which actuates the gear box 30. The motor 32 thus rotates the spindle 28 and the spindle raises the seat 60 as it turns within the nut 34. Note that the foot platform 70, in its desired selected position relative to the seat 60, also rises along with the seat, as illustrated by an arrow 93.

Further details of the seat and the seat swivel are illustrated in FIG. 3 and FIG. 4. As previously described, the seat swivel is mounted on top of the plate 36. The seat swivel 50 comprises a hold-down plate 51, a swivel plate 52 and a seat hinge plate 53. The plates 52 and 53, including the seat 60 coupled to the plates, are capable of rotating relative to the hold-down plate 51. Teflon wafers 54 are therefore placed between the moving surfaces between the plates 51 and 52 to reduce friction.

Near the rear of the seat 60, a hinge 55 is provided to connect the seat 60 to the plate 53 to allow change of the seat's inclination, which is accomplished by an adjustment nut 56 and spindle 57. The spindle 57 is attached to the underside of a seat plate 62. The seat plate 62, along with a back plate 64 (FIG. 4) are preferably made from a hard material such as wood or plastic, and are covered by a cushioning material 66.

The seat 60 includes a seat area 69 which defines a recess 68 on either side of the seat 60, which allows an angler to hold onto the seat with his inner thighs when he chooses to stand up to gain an even more elevated view.

FIG. 5 and FIG. 6 show further details of the foot platform 70 in a top view.

The platform 70 is split in two halves 72 for easy installation and removal from the elevation assembly described above. The halves 72 are provided with cut-outs 73 for clearance around a mounting plate 78. Each half 72 rests on an undercarriage 74, which has extending arms 75 for the connection to the plate 78.

As illustrated in FIG. 6, the extending arms 75 terminate in hook-shaped ends 75a which can be inserted into a pair of spaced-apart holes 79 formed in the plate 78. The entire foot platform half 72 can then be lowered as shown in FIG. 6 by an arrow 77, until the extending arms 75 come to rest on the plate 78.

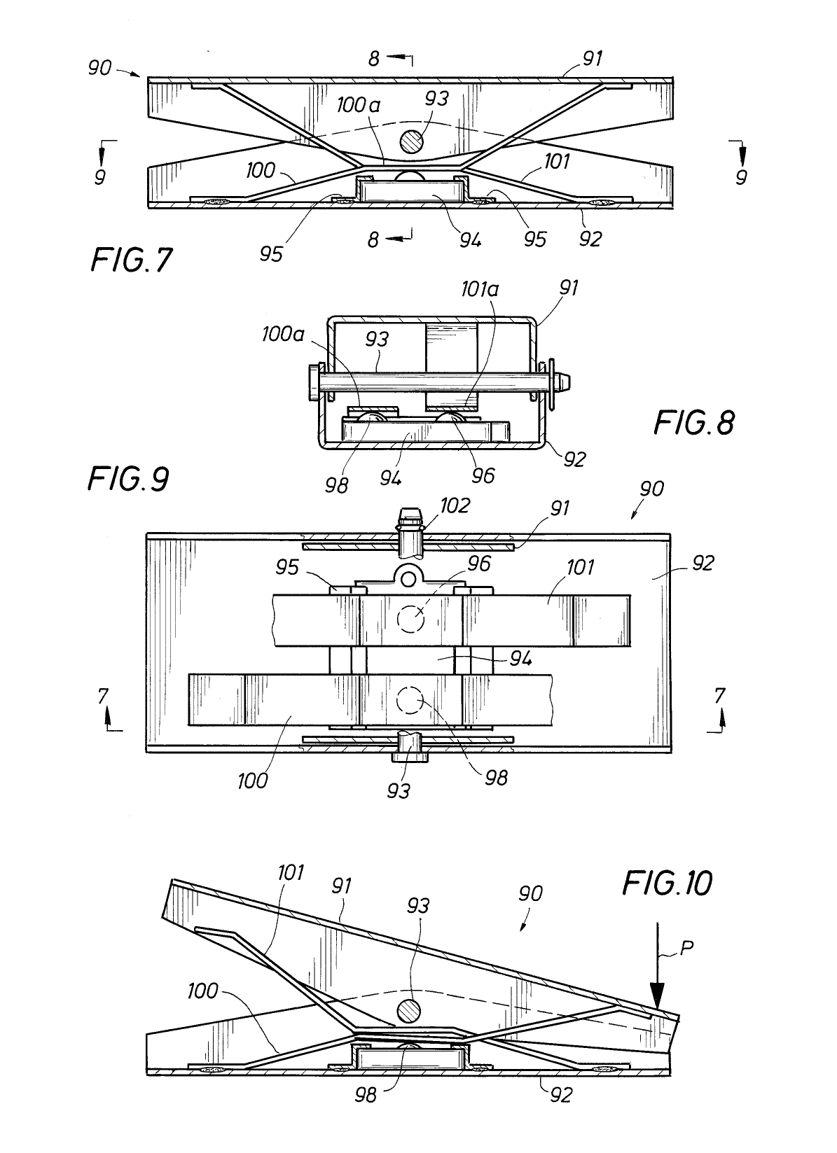

FIG. 7 through FIG. 10 show details of a presently preferred foot-operated remote control transmitter 90. The transmitter mainly comprises two U-shaped halves 91 and 92, which are pivotally connected by a pin 93. In the center of the inner bottom of half 92 is mounted an electronic switch or transmitter 94, which is held in position by a pair of opposing clamps 95. Trigger buttons 96 and 98 protrude from the top surface of the electronic transmitter. Resting on these buttons are leaf springs 100 and 101 by their center portions 100a and 101a. One end of these leaf springs is spot-welded to the bottom 92, while the other end touches the underside of the upper assembly half 91.

When pressure P is applied to either side of the assembly, as illustrated in FIG. 10, the upper half tilts down, exerts pressure on either leaf spring, which in turn presses down on either trigger button 96 or 98 of the electronic transmitter 94, sending out a signal to a receiver, which initiates power supply to motor 32, as described in more detail below.

The electronic transmitter 94 contains a battery, which has to be replaced periodically. This is made easy by removing a retainer spring 102 (FIG. 9) and the pivot pin 93 to separate the two halves 91 and 92. This allows access to the transmitter 94, which has to be pulled out from under the clamps 95, disassembled and furnished with a fresh battery. It should also be understood that a hardwired connection may be provided from the foot operated control to the motor 32, if desired.

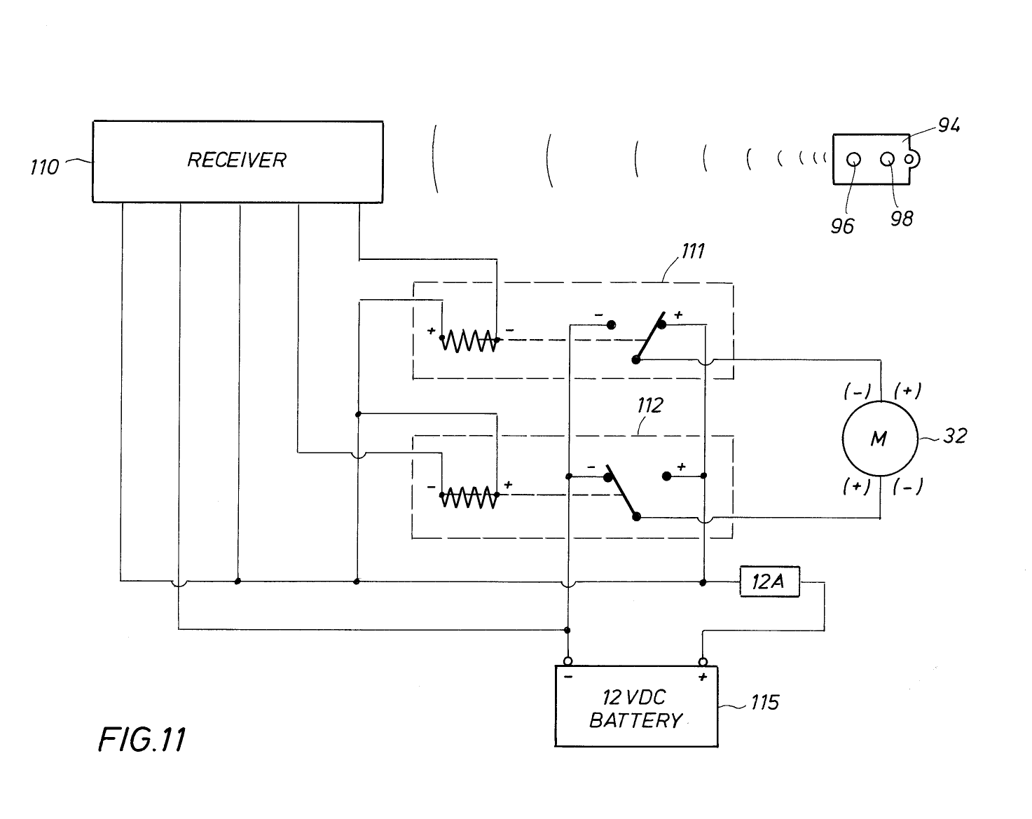

FIG. 11 illustrates a preferred electric circuit for supplying DC power to the motor 32. Those of skill in the art will appreciate that the wiring illustrated in FIG. 11 will be assembled to the structure illustrated in FIGS. 1 et seq. either inside or outside the elevation mechanism 13 as desired. The circuit includes a receiver 110, which receives one of two possible signals from the electronic transmitter 94, which causes the receiver to supply power from a battery 115 to one of two relays 111 or 112. Preferably, the battery 115 is located in an easily accessible compartment below the level of the deck 20, and wiring is run inside or outside the elevation mechanism to the motor 32. In the illustrated embodiment, the relay 111 is activated, supplying power to the motor 32 for a clockwise rotation. If the relay 112 is activated by the other signal from transmitter 94, DC power to the motor 32 is reversed, causing it to rotate the screw 28 in the opposite or counter-clockwise direction, thereby reversing the motion of the seat 60 from “up” to “down” or vice versa.

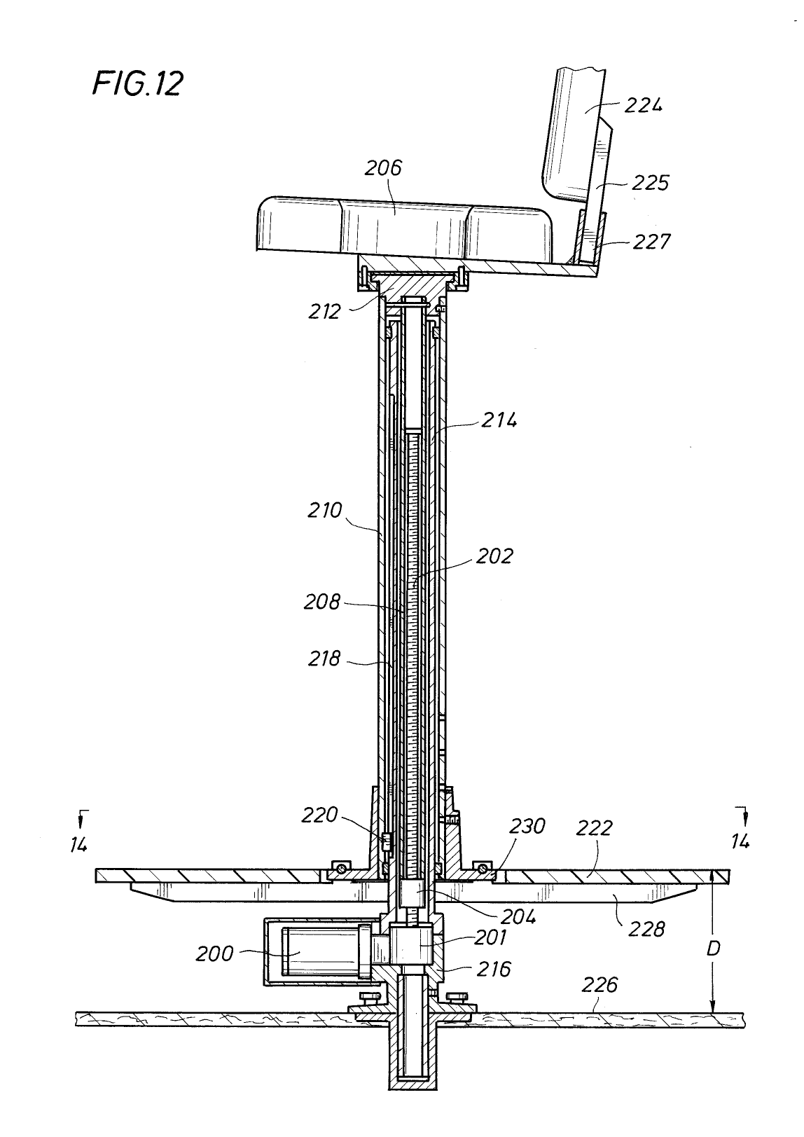

FIG. 12 illustrates an alternative embodiment of the present invention wherein a motor 200 is located at the bottom of the elevation mechanism. In this embodiment, the motor 200 is located beneath a foot platform 222, which preferably comprises two platform halves, as shown and described below. This way, the motor 200 is not in the way when a person, sitting on a seat 206, is rotating around on the swiveling seat. To accommodate the location of the motor beneath the foot platform, a spindle 202 extends above the motor 200. The spindle 202 is rotated by the motor through a gear box 201 and the rotation of the spindle 202 pushes a nut 204 upwards.

By rotating the spindle 202 through the nut 204, the nut moves in an upward or downward direction (depending on the direction of rotation of the spindle 202), and since the nut 204 is mechanically coupled to an inner tube 208, the inner tube 208 moves up and down with the nut 204. The upper end of the tube 208 is connected to an outer tube 210 through a swivel head 212. The motor 200 is mounted to a motor housing 216, and the motor housing 216 extends to a stanchion tube 214. Thus, the stanchion tube 214 remains stationary, along with the motor housing, when the spindle 202 is rotated. The stanchion tube 214 is equipped with a keyway 218, in which rides a key 220 that is part of the outer tube 210. This way, none of the tubes can rotate while the spindle 202 rotates.

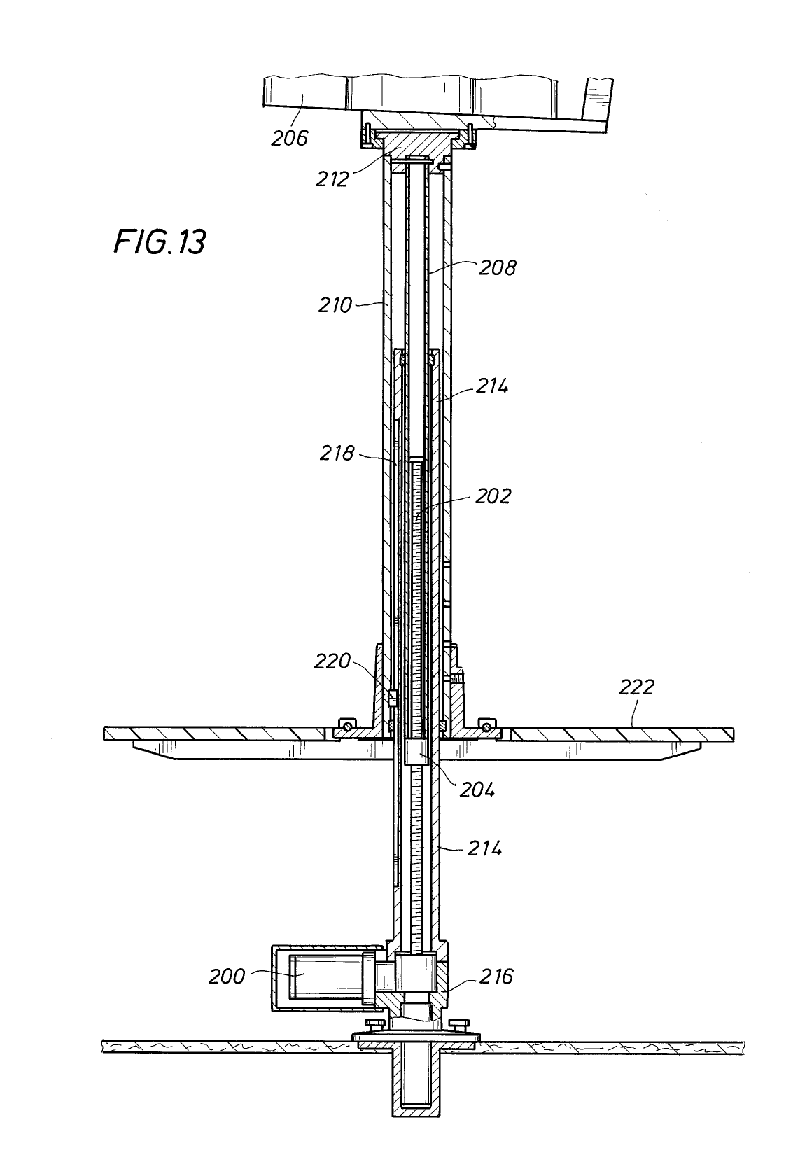

FIG. 13 shows the foot platform 222 partially raised to clarify the motion of the individual parts. Note that the nut 204 has moved up, staying approximately level with the foot platform, while the tubular elements have telescoped upward. In this way, the seat 206 can be raised in height (at the “all the way up” position) by slightly less than twice the length of the outer tube 210.

Returning briefly to FIG. 12, the presently preferred embodiment also includes a removable backrest 224. Rather than the unitary structure depicted in FIG. 1, the backrest 224, is mounted to a seatback mounting plate 225, which slides into a receiving bracket 227 and is held there with bolts or the like (not shown). In this embodiment, the backrest can thus be removed and stowed away, leaving a backless stool for the use of the angler, if desired.

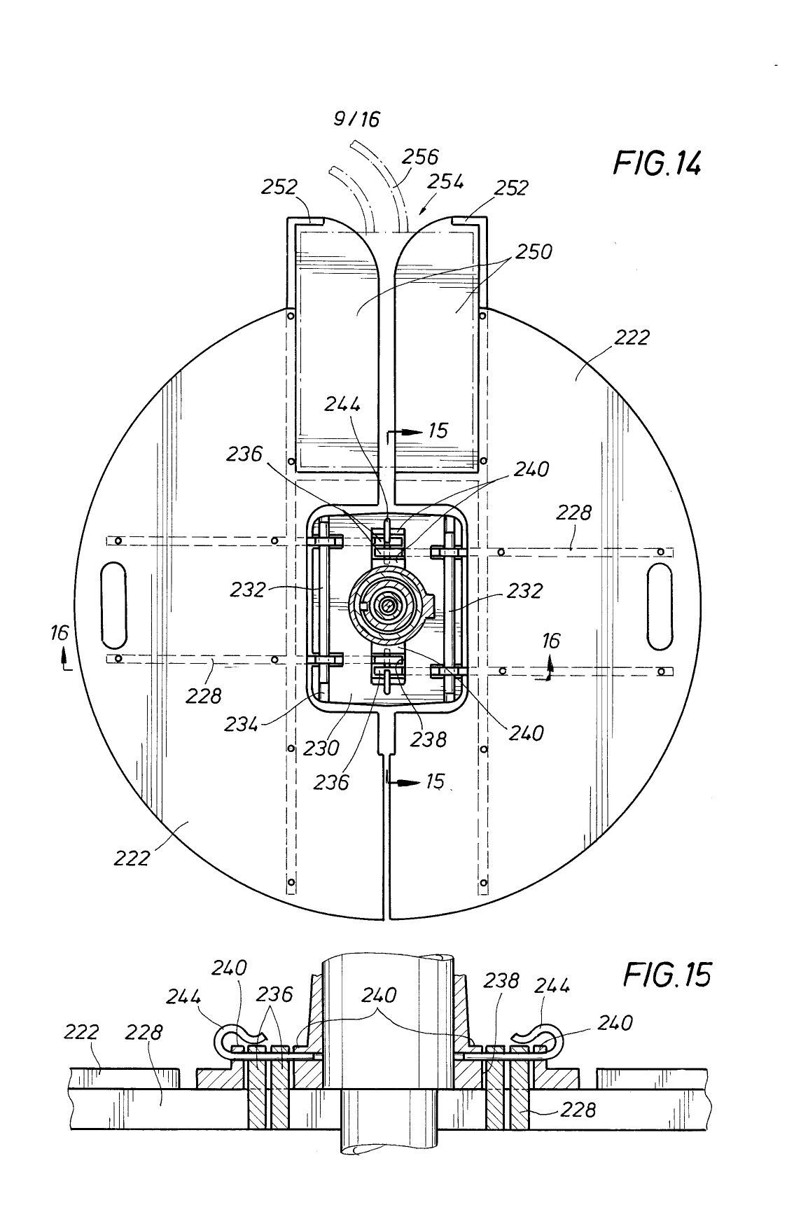

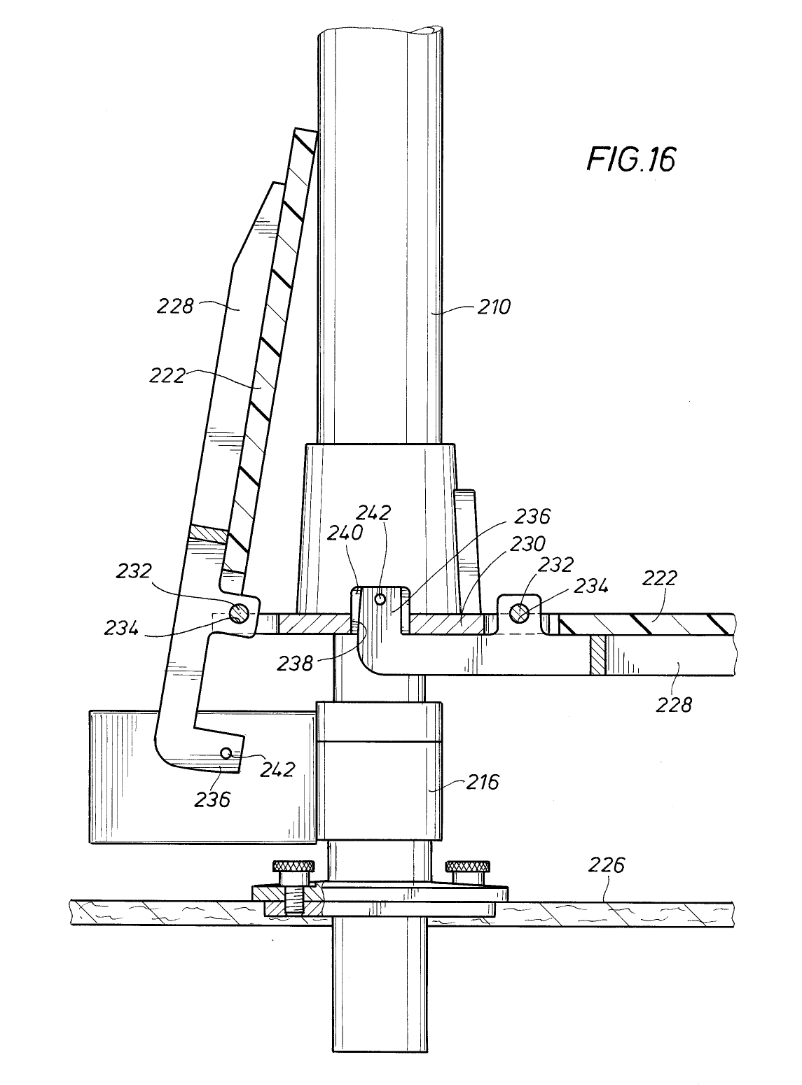

As shown in FIG. 12, a distance D defines the height of the foot platform above a boat deck 226. This distance is preferably roughly about the height of a typical stair riser, or about 8 inches, even though the motor takes up additional space beneath the foot platform in this embodiment. To help in this specification, the suspension of the foot platform is preferably changed slightly. Support arms 228 are positioned underneath a platform 230, as illustrated in more detail in FIGS. 14, 15, and 16. The support arms 228 rest in a set of hinge grooves 234 of the platform 230 by way of hinge pins 232. An extension 236 of a support arm 228 protrudes upwards through an aperture 238 in the platform 230.

When both halves of the platform 222 are in place, all extensions 236 are in line, and a set of holes 242 in these extensions line up so that a safety or cotter pin 244 can be installed, preventing an accidental upward tilting of the platform halves, such as for example when someone steps on a platform half at a point between the hinge pins 232 and the center split of the platform. The holes 242 in the upward protrusions 240 of platform 230 accommodate the pins 242. Removing these pins 242 allows the platform halves 222 to be rotated up, as illustrated on the left side of FIG. 16. The halves can be leaned against tube 210 as illustrated, when it is desirable to have more walking space around the chair, or they can be removed altogether by just lifting them up.

FIG. 14 further shows a recessed area 250 which serves to accommodate foot control devices for the commonly used trolling motors. Inward extensions 252 keep the foot control in place, while leaving an open space 254 for electrical wires 256 going to the trolling motor and the boat battery.

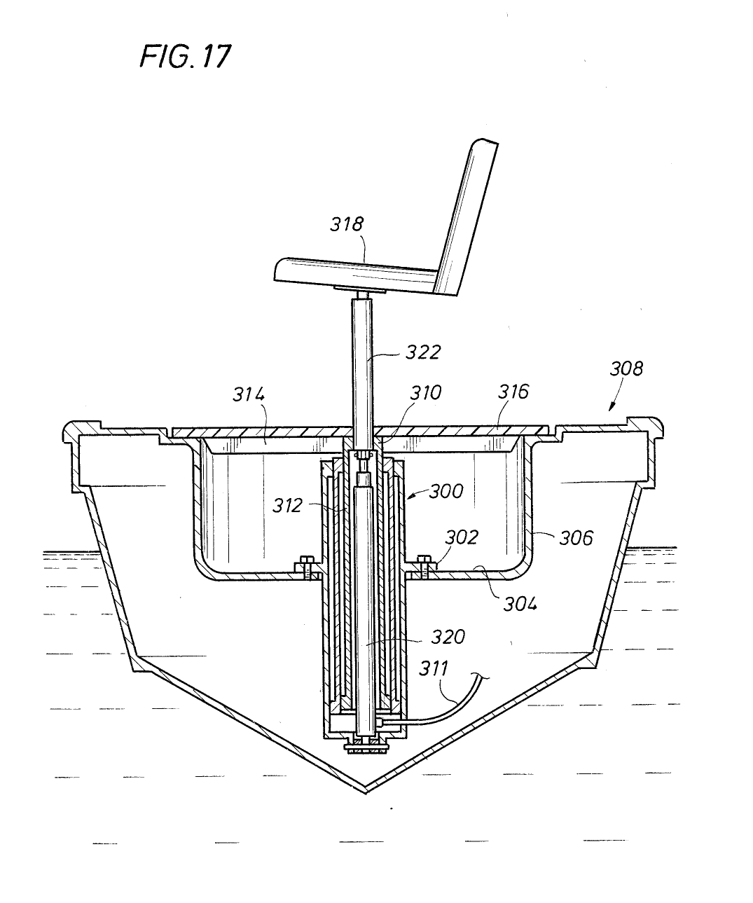

Referring now to FIG. 17, hydraulically operated embodiment of the raising and lowering portions of the seat are shown in detail. In this embodiment, a double-barrel carrying cylinder 300 includes an annular flange 302 roughly midway between the top and bottom of the cylinder 300. The carrying cylinder 300 provides mechanical support for coupling a seat to a vessel or boat, but does not include the hydraulic force components, as will be described below. The flange 302 rests upon and is preferably bolted to a bottom 304 of a storage compartment or other below-decks chamber 306 of a fishing boat 308. Attached to the top end 310 of an inner cylinder 312 is a frame 314, which in turn carries a plate 316 to provide a foot rest for a person sitting on a seat 318. The plate 316 also replaces the lid that otherwise would be provided to close the storage compartment 306.

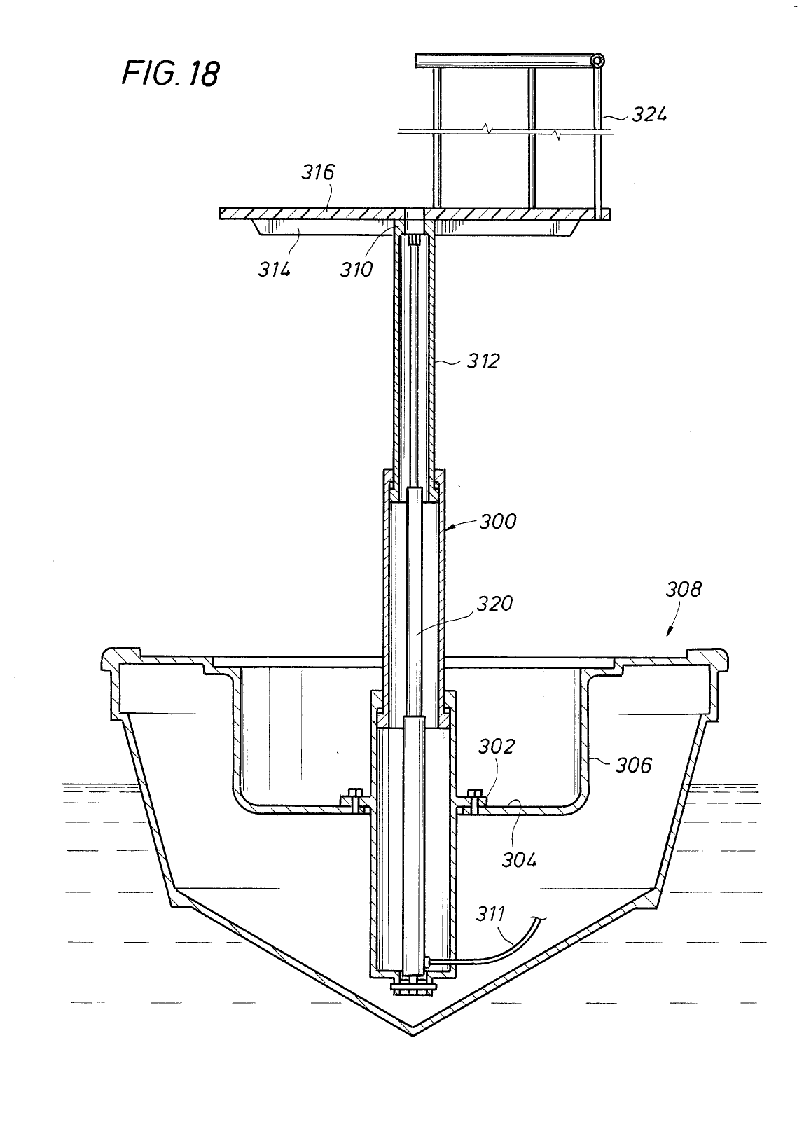

Nested within the cylinder 300 is a telescoping cylinder 320. The telescoping cylinder 320, energized by a source of hydraulic fluid under pressure by a hydraulic line 311, provides the hydraulic force for raising and lowering the seat, while supported by the carrying cylinder 300. The hydraulic telescoping cylinder 320 extends the carrying cylinder 300, as illustrated in FIG. 18, to establish an elevated position for a person occupying the seat 318. The seat 318 is coupled to the telescoping cylinder 320 by a stanchion 322.

In FIG. 18, the seat 318 and its stanchion 322 have been removed and instead a guard rail 324 has been installed. This provides an elevated observation deck to stand on and lean against the guard rail, if so desired for safety.

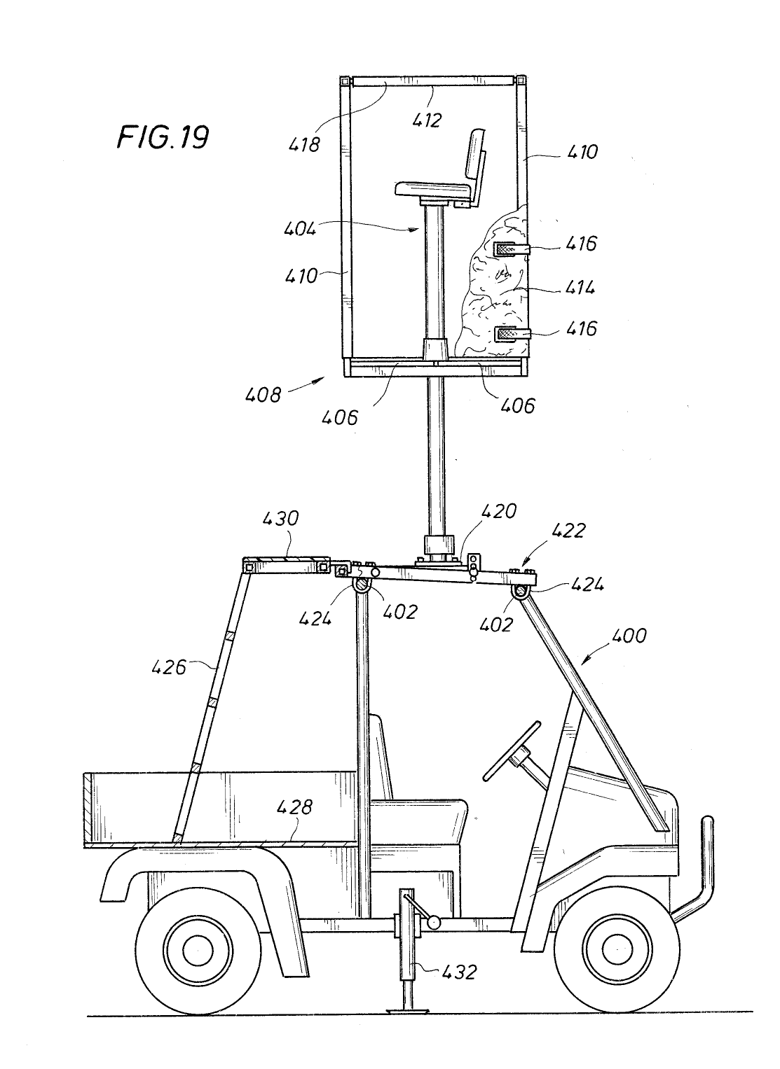

FIG. 19 illustrates a seat 404, similar to that shown in FIG. 12, adapted to be mounted on top of the rollover bars 402 of an all-terrain vehicle (ATV) 400. Thus, the present invention is equally adaptable to a boat or other vessel, or to a land vehicle and as used herein, the element to which the seat system is mounted is referred to as a host. The seat 404 in this embodiment is shown in its raised position. The seat 404 is surrounded by a cage, comprising the two halves 406 of the foot platform 408 and vertical posts 410, which are connected by bars 412 at the top. The posts 410 are preferably surrounded by a curtain of camouflage fabric 414, which may be held in place by Velcro® straps 416. The top bars 412 may provide support for a hunter's rifle and may therefore be covered by a noise dampening material 418, such as foam rubber or the like.

A bottom plate 420 of the seat 404 is preferably attached to a mounting frame 422, which in turn is attached to the rollover bars 402 by U-bolts 424. Details of the frame 422 will be described below.

A step ladder 426 rests on the bottom 428 of the ATV's loading deck, while its upper end preferably hooks onto a cross member of the frame 422. A platform 430 as part of the ladder 426 provides a convenient stepping point onto the platform 408 when the seat 404 is down in its lowest position. A screw jack 432 may be attached to each side of the ATV 400 to increase stability and, to a limited degree, bring the ATV into a sideways leveled position, when it is parked in rough and uneven terrain.

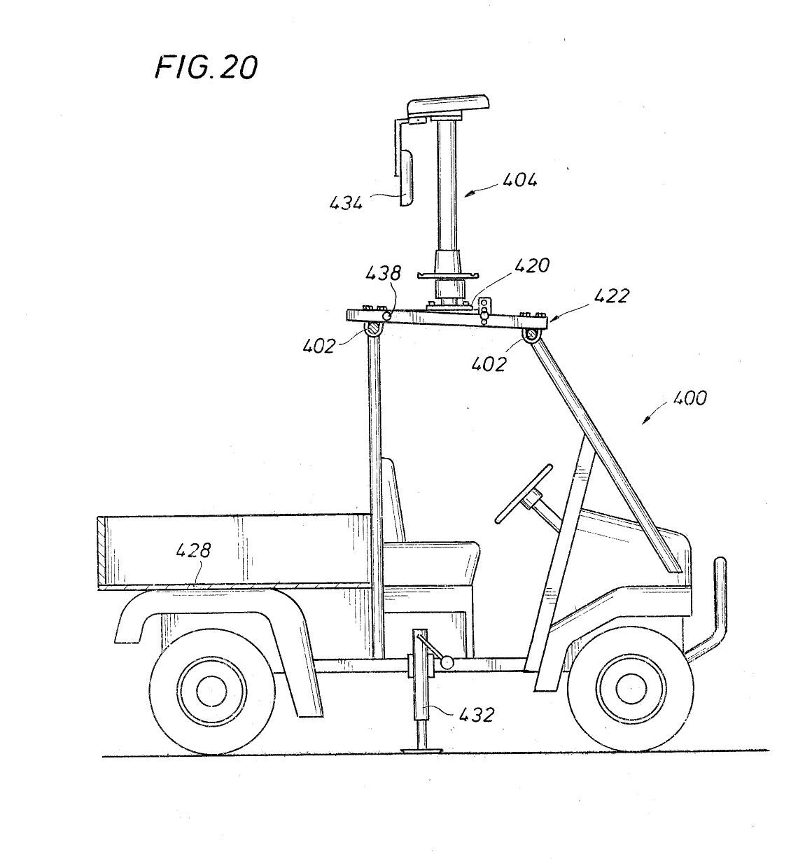

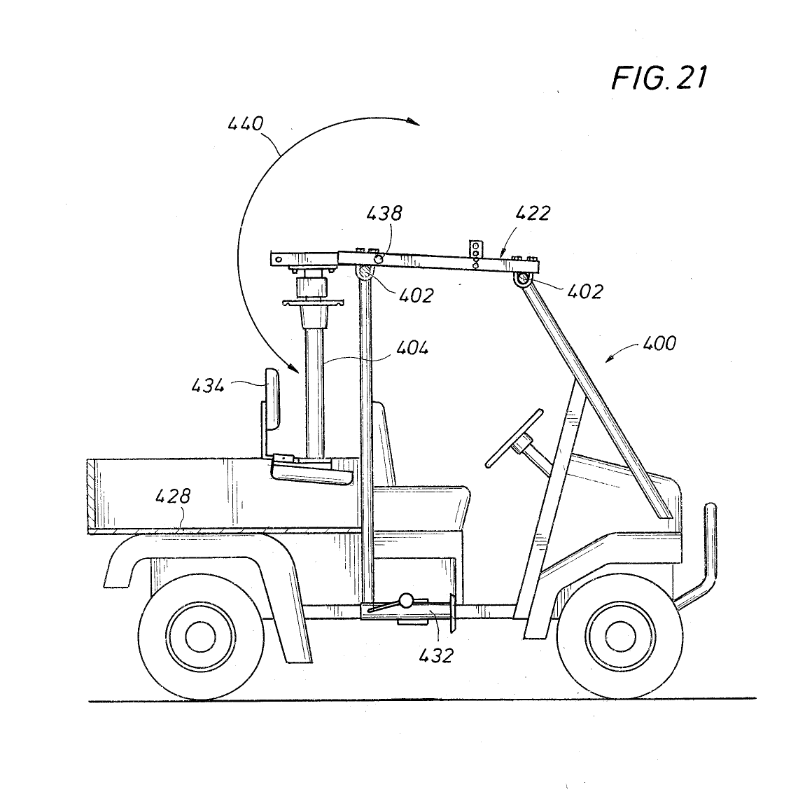

Referring now to FIG. 20, the seat 404 has been lowered, the corner posts 410 and the top bars 412 and camouflaged curtain panels 414 have been removed, the foot rest panels 406 have been taken off and stored, as well as the ladder 426. The back rest 434 of the seat 404 has been rotated into a storage position and the entire seat 404 is ready to be rotated into its traveling position around a pivot point 438, as also shown in FIG. 21 by an arrow 440. The screw jacks 432 have been retracted and rotated into traveling position.

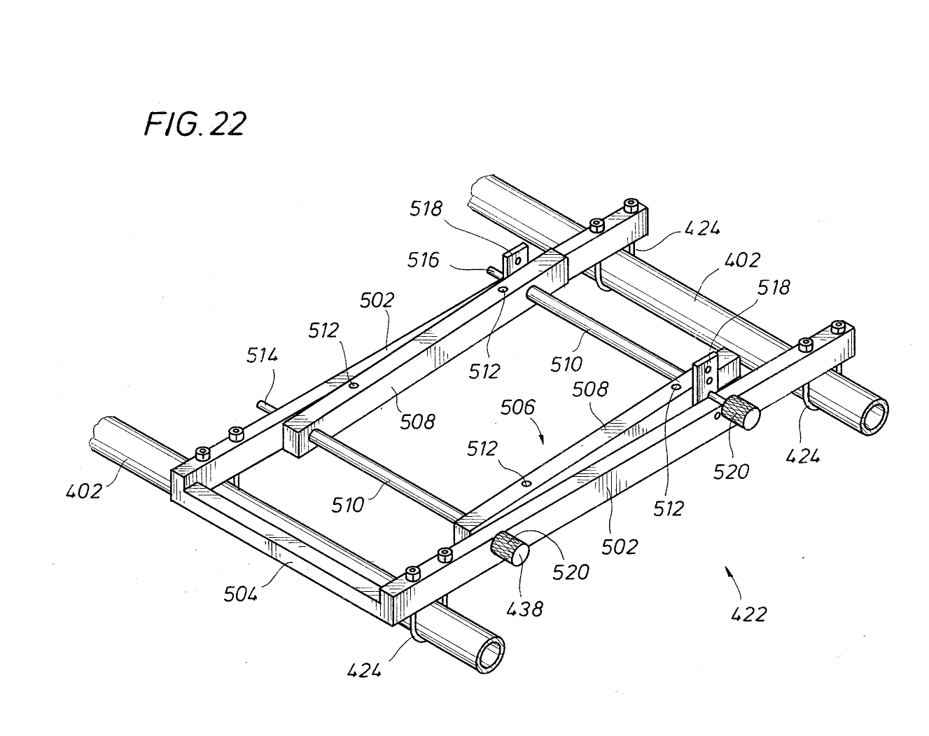

FIG. 22 illustrates a preferred embodiment of the frame 422 in detail. Two parallel bars 502 are attached to the rollover bars 402 of the ATV 400 by a set of U-bolts 424, although other coupling means may be used. The bars 502 are connected at one end by a cross bar 504, which serves to support the upper end of ladder 426, as shown in FIG. 19 and previously described. A second, inner frame 506 consists of two parallel bars 508, which are connected by guide tubes 510. Four holes 512 provide attachment points for the base plate 420 of seat 404, as shown in FIG.19. A shaft 514 extends through holes in bars 502 and through the guide tubes 510 of the inner frame 506 to provide a pivot location 438.

A second shaft 516 extends through holes in a pair of vertical, opposing plates 518, which are integral with the bars 502, and through the guide tubes 510 of the inner frame 506. A shaft 516 can be inserted through the holes in plates 518 at different levels, thereby bringing the inner frame 506 into a horizontal position, when the outer frame bars 502 are not horizontal, depending on the uneven terrain where the ATV is parked.

The shafts 514 and 516 are provided with knurled heads 520 to facilitate their installation and removal. The shaft 516 can be removed to rotate inner frame 506 counter-clockwise as viewed in FIG. 22 with the seat 404 mounted on it (as illustrated in FIG. 21).

To remove the seat 404, including the inner frame 506, from the ATV, the shafts 514 and 516 are removed and the entire frame with the seat attached are then free of the mounting mechanism.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

We claim:

1. A seat assembly for installation on a host, the seat assembly comprising:
a. a seat;
b. a mounting mechanism adapted to mount the seat assembly to the host; and
c. a hydraulic elevation mechanism between the seat and the mounting mechanism.

2. The assembly of claim 1, wherein the host comprises a boat.

3. The assembly of claim 1, wherein the host comprises a land-operated vehicle.

4. The assembly of claim 1, wherein the elevation mechanism comprises:
a. carrying cylinder mounted to the host;
b. a hydraulically operated telescoping cylinder nested within the carrying cylinder; and
c. a source of hydraulic fluid under pressure coupled to the telescoping cylinder.

5. The assembly of claim 4, wherein the host comprises a boat, and further comprising an annular flange extending outwardly from the carrying cylinder for mounting to the boat.

6. The assembly of claim 5, further comprising a foot platform mechanically coupled to the carrying cylinder.

7. The assembly of claim 6, further comprising a remote control device to remotely operate the elevation mechanism.

8. The assembly of claim 7, wherein the remote control device comprises a foot operated control mounted to the foot platform.

9. The assembly of claim 3, further comprising a cage surrounding the seat.

10. The assembly of claim 9, wherein the cage is covered with a curtain.

11. The assembly of claim 3, wherein the mounting mechanism includes a mounting frame.

12. The assembly of claim 11, wherein the mounting frame includes a plurality of releasable U-bolts, enabling the releasable attachment of the assembly to the vehicle.

13. The assembly of claim 11, wherein the mounting frame includes a pivoting axis, enabling the positioning the assembly at a first, operable position and a second, stowed position.

14. The assembly of claim 11, further comprising a ladder releasably mounted to the mounting plate.

15. An assembly for installation on a host, the assembly comprising:
a. a platform having a periphery;
b. a handrail positioned a height above the platform and extending at least part way around the periphery of the platform
b. a mounting mechanism adapted to mount the platform to the host; and
c. a hydraulic elevation mechanism between the platform and the mounting mechanism.
